(19) United States
(12) Patent Application Publication
(10) Pub. No.: US 2004/0267534 A1
(43) Pub. Date: Dec. 30, 2004

(54) Selective vehicle component control

(75) Inventors: Frederick J. Beiermeister, Farmington Hills, MI (US); Christopher L. Oesterling, Troy, MI (US); Jeffrey M. Stefan, Clawson, MI (US)

Correspondence Address: General Motors Corporation, Legal Staff, Mail Code 482-C23-B21, 300 Renaissance Center, P.O. Box 300, Detroit, MI, 48265-3000, US

(73) Assignee: General Motors Corporation

(21) Appl. No.: 10/607,861

(22) Filed: Jun. 27, 2003

(51) Int. Cl. G10L 11/00

(52) U.S. Cl. 704/275

(57) ABSTRACT

The invention provides a system and method for selective vehicle component control. Receiving a voice recognition engine activation signal activates a voice recognition engine in an in-vehicle telematics unit. A voice command is then received at the voice recognition engine of the in-vehicle telematics unit. A vehicle component control command is sent to a control entity from the in-vehicle telematics unit based on the voice command received. Another aspect of the invention provides a computer usable medium that includes a program for selective vehicle component control.

### FIELD OF THE INVENTION

This invention relates generally to telematics units for mobile vehicles. In particular the invention relates to a system and method for selective vehicle component control.

### BACKGROUND OF THE INVENTION

One of the fastest growing areas-of communications technology is related to automobile network solutions. The- demands and potential for wireless vehicle communication, networking and diagnostic services have escalated in recent years, with projections that by 2006 almost all new American cars will have some level of telematics service. Although many vehicles on the road today have limited wireless communication functions, such as unlocking a door and setting or disabling a car alarm, new vehicles offer additional wireless communication systems that help personalize comfort settings, run maintenance and diagnostic functions, place telephone calls, access call-center information, update controller systems, determine vehicle location, assist in tracking vehicle after a theft of the vehicle and provide other vehicle-related services. Drivers can call telematics call centers to receive navigational, concierge, emergency, and location services, as well as other specialized help such as locating the geographical position of a vehicle when it has been stolen and honking the horn of a vehicle when it cannot be located in a large parking garage.

A common method of vehicle security involves disabling the vehicle ignition, if entry is attempted while the security system is armed. While this method is effective it is limited to disabling ignition. These security systems rely on wireless transmitters to arm and disarm the vehicle and are susceptible to being broken by unauthorized persons. In an example, a person such as a family member has access to a transmitter to disarm the system but may not be authorized to do so.

While disarming vehicle ignition is a primary concern a user may also desire to disable certain components of a vehicle while leaving others active. When leaving a vehicle with a valet, repair shop, detail shop, or other service provider a user cannot secure the vehicle's phone, audio system, navigation system, climate control, email access, or other vehicle functions since the service provider has authorized access to the vehicle. Any vehicle components the owner cannot take with them or lockdown are therefore accessible to the, service provider. The owner may also wish to limit access to vehicle components by friends, family members or others with authorized access to the vehicle.

Lost transmitters are a common problem with most current vehicle security systems. Without a transmitter the owner must obtain a replacement to access his vehicle. Usually the owner will have 2 or 3 transmitters in his possession so that he may provide a transmitter to other drivers and retain a spare transmitter. The owner is therefore presented with the additional task of securing spare transmitters.

It is desirable therefore, to provide a system and method for selective vehicle component control, that overcomes the challenges and obstacles described above.

### SUMMARY OF THE INVENTION

The present invention provides a system and method for selective vehicle component control. Receiving a voice recognition engine activation signal activates a voice recognition engine in an in-vehicle telematics unit. A voice command is then received at the voice recognition engine of the in-vehicle telematics unit. A vehicle component control command is sent t control entity from the in-vehicle telematics unit based on the voice command received. Another aspect of the invention provides a computer usable medium that includes a program for selective vehicle component control.

The aforementioned and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic diagram of a system for selective vehicle component control in accordance with one embodiment of the current invention.

FIG. 2 is a flow diagram of a method for selective vehicle component control in accordance with one embodiment of the current invention.

FIG. 3 is schematic of the telematics unit of one embodiment of a system for selective vehicle component control, in accordance with the current invention.

### DETAILED DESCRIPTION OF THE PRESENTLY PREFERRED EMBODIMENTS

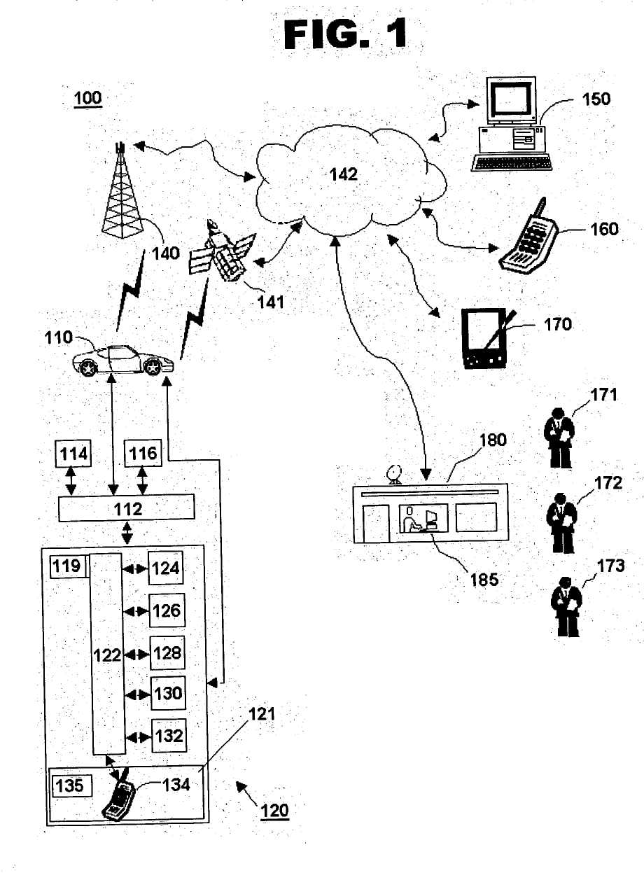

FIG. 1 is a schematic diagram of a system for selective vehicle component control in accordance with one embodiment of the current invention at 100. Selective vehicle component control system 100 includes a mobile vehicle 110, a telematics unit 120, one or more wireless carrier systems 140 or satellite carrier systems 141, one or more communication networks 142, and one or more call centers 180. In one embodiment, mobile vehicle 110 is a vehicle such as a car or truck equipped with suitable hardware and software for transmitting and receiving voice and data communications.

In one embodiment, telematics unit 120 includes a digital signal processor (DSP) 122 connected to a wireless modem 124, a global positioning system (GPS) receiver or GPS unit 126, an in-vehicle memory 128, a microphone 130, one or more speakers 132, an embedded or in-vehicle phone 134 or internet access appliance 135. DSP 122 is also be referred to as a microcontroller, controller, host processor, or vehicle communications processor. In one embodiment, GPS unit 126 provides longitude and latitude coordinates of the vehicle. In-vehicle phone 134 may be an analog, digital, dual-mode, dual-band, multi-mode or multi-band cellular phone.

Telematics unit 120 can store vehicle data upload (VDU) records in in-vehicle memory 128. Telematics unit 120 can set or reset calling-state indicators and can enable or disable various cellular-phone, telematics-unit functions and vehicle components when directed by microcode running on DSP 122. Telematics unit 120 can send and receive over-the-air messages using, for example, a pseudo-standard air-interface function or other proprietary and non-proprietary communication links.

DSP 122 executes various computer programs and computer program code that control programming and operational modes of electronic and mechanical systems within telematics unit 120. In one embodiment, DSP 122 controls communications between telematics unit 120, wireless carrier system 140 or satellite carrier system 141 and call center 180. In one embodiment, a voice-recognition application is installed in telematics unit 120 that can translate human voice in put through microphone 130 to digital signals. For example, programming of in-vehicle phone 134 is controlled with verbal commands that are translated by voice-recognition software executed by DSP 122. Alternatively, pushing buttons on an interface of telematics unit 120 or in-vehicle phone 134 may be used to change a phone number and other phone configuration settings. In one embodiment, the interface to telematics unit 120 includes one or more buttons on the telematics unit, radio console, or associated keyboard or keypad. The interface to telematics unit 120 may, include other forms of preference and data entry including touch-screens, wired or wireless keypad remotes, or other wirelessly connected devices such as Bluetooth-enabled devices or 802.11-enabled devices.

DSP 122 controls, generates and accepts digital signals transmitted between telematics unit 120 and a vehicle communication bus 112 that is connected to various vehicle components 114 and sensors 116 in mobile vehicle 110. In one embodiment, DSP 122 activates various programming and operation modes, as well as provides for data transfers. Signals from DSP 122 are, in an example, translated into voice messages and sent out through speaker 132. Generated voice messages include a command prompt, a password prompt or a feedback message notifying user that a command has been executed.

In one embodiment, mobile vehicle 110 via telematics unit 120 sends and receives radio transmissions from wireless carrier system 140, or satellite carrier system 141. Wireless carrier system 140, or satellite carrier system 141 may be any suitable system for transmitting a signal from mobile vehicle 110 to communication network 142.

Communication network 142 includes services from mobile telephone switching offices, wireless networks, public-switched telephone networks, and Internet protocol (IP) networks. Communication network 142 may comprise a wired network, an optical network, a fiber network, another wireless network, or any combination thereof. Communication network 142 connects to mobile vehicle 110 via wireless carrier system 140, or satellite carrier system 141. In one embodiment, communication network 142 connects wireless carrier system 140 or satellite carrier system 141 to user computer 150, cellular phone 160, handheld device, such as personal digital assistant 165, and call center 180. Communication network 142, in one example, sends and receives short messages according to established protocols such as IS-637 standards for short message service (SMS), IS-136 air-interface standards for SMS, and GSM 03.40 and 09.02 standards. Similar to paging, an SMS communication, in such an example, is posted along with an intended recipient, such as a communication device in mobile vehicle 110.

Call center 180 may be a location where many calls may be received and serviced at the same time, or where many calls may be sent at the same time. In one example, the call center 180 is a telematics call center, prescribing communications to and from telematics unit 120 in mobile vehicle 110. In another example, call center 180 is a voice call center, providing verbal communications between an advisor 185 in the call center 180 and a subscriber. In another example, call center 180 contains each of these functions. Call center 180 may receive a telematics unit access request from a telematics user via wireless carrier system 140, satellite carrier system 141, or communication network 142.

Call center 180 provides services to telematics unit 120. Communication services advisor 185 one of a number of support services to a subscriber. Call center 180 may transmit data via data signal, such as a vehicle data upload (VDU), to telematics unit 120 in mobile vehicle 110 through wireless carrier system 140, satellite carrier systems 141, or communication network 142.

Communication services advisor 185 facilitates one of a number of support services to a subscriber. Communication services advisor 185 may be a real advisor or a virtual advisor. A real advisor is a human being in verbal communication with a user or subscriber. In one example, a virtual advisor is a synthesized voice interface responding to requests from telematics unit 120 in mobile vehicle 110. In one example, this virtual advisor includes one or more recorded messages.

Call center 180 can determine mobile identification numbers and telematics unit identifiers associated with a telematics unit access request, compare mobile identification numbers and telematics unit identifiers with a. database of identifier records, and send calling-state messages to the telematics unit 120 based on the request and identification numbers.

Mobile vehicle manufacturer 171, mobile vehicle dealer 172, or mobile vehicle owner 173 may have user computer 150 or handheld device 160. In one embodiment, local provisioning system such as user computer 150 or handheld device 160 has a wireless modem to send data through a wireless carrier system 140, or satellite carrier system 141, which connects to communication network 142. Data is received at call center 180. In one embodiment, call Center 180 may have any suitable hardware and software capable of providing web services to help transmit messages and data signals from local provisioning system, such as, user computer 150 or handheld device 160 to telematics unit 120 in mobile vehicle 110. In another embodiment, user computer 150 or handheld device 160 has suitable hardware and software to connect to mobile vehicle 110 using a direct link to a mobile vehicle onboard data port.

In the current embodiment, voice recognition software is installed in telematics unit 120 and is referred to as a voice recognition engine 119. Voice recognition software is executed by DSP 122. In an example, pressing a white button in vehicle 110 activates voice recognition engine 119. In an example, pressing the white button sends a discrete signal that places the telematics unit in audio recognition mode allowing it to respond to voice commands. In another embodiment, pressing a blue button in vehicle 110 initiates communication with call center advisor 185. A voice command is uttered to control a particular vehicle component 114. Voice recognition engine 119 processes the voice command and outputs the proper instructions to the control entity that controls the vehicle component 114. Two classes of components are controlled: telematics components 121 and non-telematics components 114. The telematics components 121 are local to the telematics unit 120 and access to vehicle bus 112 is not required when controlling these components. Examples of telematics components 121 are personal calling access or phone 134,and internet access 135. Control of non-telematics components 114 usually requires access to the vehicle bus 112 for communication with the particular vehicle component's control entity. A control message is placed on vehicle bus 112 directing a particular non-telematics component 114 to function in a particular manner. The control message is received and processed by the vehicle component's control entity. Examples of non-telematics components 114 are the ignition system, the navigation system, the audio system and the climate control system. Telematics unit 120 contains a selection table that is stored in a portion of in-vehicle memory 128. The selection table provides a reference for telematics unit 120 in routing vehicle component control commands to a component's appropriate control entity. Vehicle component control commands are routed either locally to the telematics unit 120 or over vehicle bus 112 to a control entity for a vehicle component 114. Voice recognition engine 119 requires a password to verify authorized access to the selective vehicle component control system. Call center advisor 185 can provide selective vehicle component control service and password-reset service. In one embodiment, the system is configured to send a verification message to a predefined location utilizing communication network 142. If the system is so configured a car rental company or other vehicle owner can maintain a record of each time a component is controlled. For example, a car rental company uses this record to charge a customer for use of the selective vehicle component control service. A vehicle owner can use the record to maintain a log of all access to the system and to receive an alert of any unauthorized attempt to access the system.

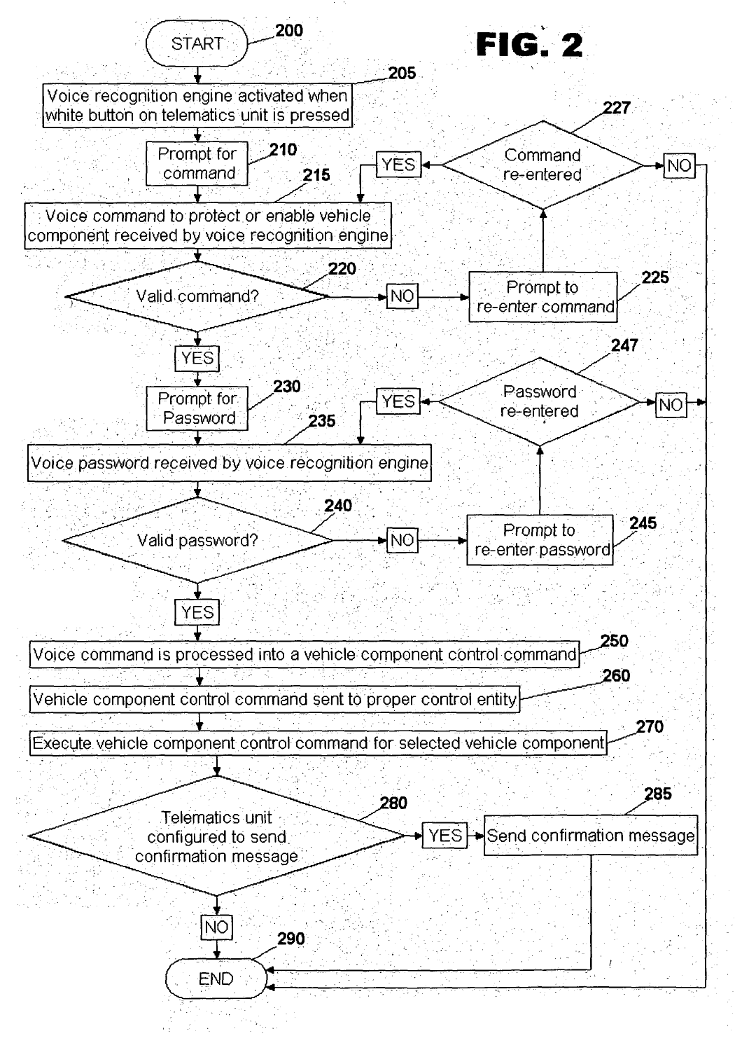

FIG. 2 is a flow diagram of a method for selective vehicle component control in accordance with one embodiment of the current invention. The method for selective control of vehicle components begins 200 when the voice recognition engine of the telematics unit receives an activation signal because the user has pressed the white button on the telematics unit 205. A voice prompt is sent alerting the user that the voice recognition engine is ready to receive a voice command 210. The voice recognition engine receives the uttered voice command 215. The voice command is a command to either protect or to enable a vehicle component. The uttered command may or may not be a valid command 220.

If the voice recognition engine of the telematics unit does not receive a valid voice command a voice prompt is sent alerting the user that the voice command was invalid or not understood and prompting for the command be re-entered 225. The user has the opportunity of retrying the voice command or aborting the selective vehicle component control method 227. If the command is not re-entered, the method ends.290.

If the voice recognition engine of the telematics unit receives a valid voice command, a voice prompt is sent to the user, requesting a voice password 230. The password is used to confirm user is authorized to access the selective vehicle component control functions. The voice password is typically a four-digit number, but may also be an alias or name-tag assigned by the user. The voice recognition engine receives the uttered voice password 235 which may or may not be a valid voice password 240.

If the voice recognition engine of the telematics unit does not receive a valid voice password, a voice prompt is sent alerting the user that the password. was invalid or not understood and asking the user to re-enter the password 245. The user has the opportunity to retry uttering the voice password or aborting the vehicle selective component control method 247. In one embodiment, the user is able to contact a call center advisor and request a password reset. If the user does not re-enter the password, the method ends 295 If the voice recognition engine receives a valid password the voice command is processed into a., vehicle component control command 250 and the vehicle component control command is routed to the proper control entity 260. The vehicle component control command is then executed by the control entity 270, protecting or enabling the desired component. In one embodiment, the telematics unit is configured to send a confirmation message 280. The confirmation message provides data regarding the use of the selective vehicle component control system and method If the telematic unit is not configured to send a confirmation message the method ends 290. If the telematic unit is configured to send a confirmation message, the message is sent 285, and the method ends 290.

A simple context-free grammar is used within the voice recognition engine. This grammar is a set of rules, that specify the required syntax for the voice commands, and symbols that provide the building blocks to construct all allowed voice commands. This extensible grammar allows addition of new components as necessary. The grammar is:

Start → <noun_phrase> <digit_phrase>
<noun_phrase> → <verb><noun>
<digit_phrase> → ZERO, ONE, . . . , ONE HUNDRED
<verb> → PROTECT, ENABLE
<noun> → PHONE, EMAIL, IGNITION, AUDIO, NAVIGATION,

CLIMATE

The following example illustrates the use the selective vehicle component control system and method using context-free grammar where personal calling is protected. The user presses the white button and utters “PROTECT PHONE. ” The voice recognition system the retrieves the vehicle identification number (VIN) and asks the user for a four character voice password. The user utters the voice password, the voice password is verified, and personal calling is disabled. The password may be an alias or name tag representing the actual four digits of the password. When the user wishes to restore personal calling, the user presses the white button and utters “ENABLE PHONE. ” The voice recognition system prompts the user for the voice password, and personal calling is restored when the correct voice password is uttered. If the user cannot remember the voice password, a password reset service is offered. In one example, to reset a voice password, the user presses the blue button on the telematics unit, verifies their identity with an Advisor, and the voice password is reset. The user will enter a new password that is retained by the telematics unit and the call center. In another example, the Advisor also protects or enables the particular vehicle component, in this case personal calling, while resetting the voice password.

In one embodiment, the user specifies a disable command after a specified number of ignition cycles, which is indicated by the <digit_phrase> production of the context-free grammar. The digit utterance specifies the number of ignition cycles that will occur before the disable command is executed. If a user utters ′PROTECT PHONE FIVE′then the personal calling feature will be disabled after five ignition cycles. If a user utters ″PROTECT PHONE′, then the lack of a digit phrase utterance causes the personal calling feature to be unconditionally disabled.

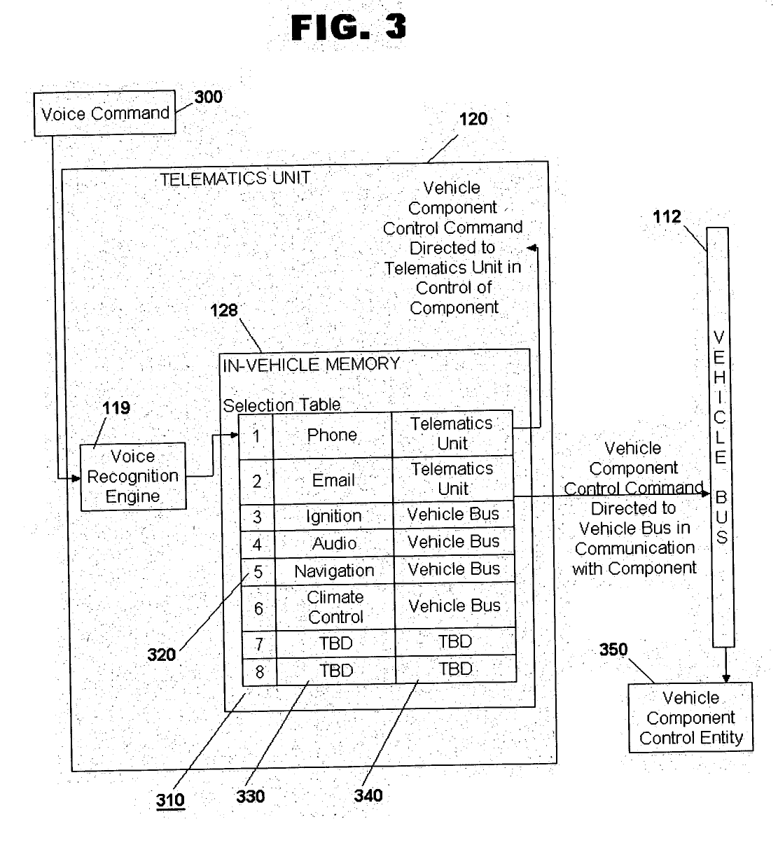

FIG. 3 is schematic of the telematics unit of one embodiment of a system for selective vehicle component control, in accordance with the current invention. The selection table 310 is resident in in-vehicle memory 128 of telematics unit 120. A voice command 300 is processed, by voice recognition engine 119, into a vehicle component control command sent from telematics unit 120. Telematics unit 120 uses selection table 310 to properly route a given command. Each available function is assigned an integer index 320 into the table. The integer index 320 points to a component identifier 330, such as phone, email, ignition, etc. Each component identifier is then associated with a secondary identifier 340 that points to the proper location to route the vehicle component control command. Vehicle component control commands are either directed to the telematics unit 120 in control of the component or to the vehicle bus 112 in communication with the component's control entity 350. For example, the telematics unit controls personal calling features, therefore, commands related to phone function are routed within the telematics unit. Alternately, control of the ignition system requires access to the vehicle bus. Vehicle component control commands relating to the ignition system are routed over the vehicle bus 112 to the powertrain control module (PCM) which controls the functions of the ignition system. Selection table 310 can be edited, as necessary, for the addition or deletion of vehicle components.

While embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method for selective vehicle component control, comprising:
receiving a voice recognition engine activation signal to activate a voice recognition engine in an in-vehicle telematics unit;
receiving a voice command at the voice recognition engine of the in-vehicle telematics unit; and
sending a vehicle component control command to a control entity from the in-vehicle telematics unit based on the received voice command.

2. The method of claim 1 wherein receiving the voice recognition engine activation comprises:
pushing a button on the telematics unit to send the voice recognition engine activation signal.

3. The method of claim 1 wherein the vehicle component control command is a protect component command.

4. The method of claim 1 wherein the vehicle component control command is an enable component command.

5. The method of claim 1 wherein receiving the voice command comprises:
sending a prompt for a voice command;
interpreting the voice command according to a simple context-free grammar;
verifying the voice command is valid based on the interpretation.

6. The method of claim 1 wherein receiving the voice command comprises:
sending a prompt for an voice password;
receiving the voice password at the voice recognition engine;
comparing the received voice password to a password stored in the in-vehicle telematics unit; and
verifying the voice password is valid based on the comparison of the received voice password and the stored password.

7. The method of claim 1 wherein sending a vehicle component control command comprises:
processing the voice command into the vehicle component control command;
comparing the vehicle component control command to a selection table entry in the telematics unit; and
routing the vehicle component control command to the control entity for the vehicle component based on the selection table entry comparison.

8. The method of claim 1 further comprising:
sending a verification message when the vehicle component control command is sent.

9. A computer usable medium including a program for selective vehicle component control, comprising:
computer program code to receive a voice recognition engine activation signal to activate a voice recognition engine in an in-vehicle telematics unit;
computer program code to receive a voice command at the voice recognition engine of the in-vehicle telematics unit; and
computer program code to send a vehicle component control command to a control entity from the in-vehicle telematics unit based on the received voice command.

10. The computer usable medium of claim 9 wherein the computer program code to receive the voice command comprises:
computer program code to send a prompt for a voice command;
computer program code to interpret the voice command according to a simple context-free grammar;
computer program code to verify the voice command is valid based on the interpretation.

11. The computer usable medium of claim 9 wherein the computer program code to receive the voice command comprises:
computer program code to send a prompt for an voice password;
computer program code to receive the voice password at the voice recognition engine;
computer program code to compare the received voice password to a password stored in the in-vehicle telematics unit; and
computer program code to verify the voice password is valid based on the comparison of the received voice password and the stored password.

12. The computer usable medium of claim 9 wherein the computer program code to send a vehicle component control command comprises:
computer program code to process the voice command into the vehicle component control command;
computer program code to compare the vehicle component control command to a selection table entry in the telematics unit; and
computer program code to route the vehicle component control command to the control entity for the vehicle component based on the selection table entry comparison.

13. The computer usable medium of claim 9 further comprising:
computer program code to send a verification message when the vehicle component control command is sent.

14. A system for selective vehicle component control, comprising:
means-for receiving a voice recognition engine activation signal to activate a voice recognition engine in an in-vehicle telematics unit;
means for receiving a voice command at the voice recognition engine of the in-vehicle telematics unit; and
means for sending a vehicle component control command to a control entity from the in-vehicle telematics unit based on the received voice command.

15. The system of claim 14 wherein the means for receiving the voice command comprises:
means for sending a prompt for a voice command;
means for interpreting the voice command according to a simple context-free grammar;
means for verifying the voice command is valid based on the interpretation.

16. The system of claim 14 wherein the means for receiving the voice command comprises:
means for sending a prompt for an voice password;
means for receiving the voice password at the voice recognition engine;
means for comparing the received voice password to a password stored in the in-vehicle telematics unit; and
means for verifying the voice password is valid based on the comparison of the received voice password and the stored password.

17. The system of claim 14 wherein the means for sending a vehicle component control command comprises:
means for processing the voice command into the vehicle component control command;
means for comparing the vehicle component control command to a selection table entry in the telematics unit; and
means for routing the vehicle component control command to the control entity for the vehicle component based on the selection table entry comparison.

18. The system of claim 14 further comprising:
means for sending a verification message when the vehicle component control command is sent.
